(19) United States
(12) Patent Application Publication
(10) Pub. No.: US 2022/0282987 A1
(43) Pub. Date: Sep. 8, 2022

(54) INFORMATION PROCESSING SYSTEM, INFORMATION PROCESSING DEVICE, AND INFORMATION PROCESSING METHOD

(71) Applicant: SONY GROUP CORPORATION, TOKYO (JP)

(72) Inventors: MIKIO NAKAI, TOKYO (JP); RYO WATANABE, TOKYO (JP); KAZUNORI YAMAMOTO, TOKYO (JP); MARI IKENAGA, TOKYO (JP)

(21) Appl. No.: 17/630,247

(22) PCT Filed: Jul. 6, 2020
(86) PCT No.: PCT/JP2020/026330

§ 371 Date: Jan. 26, 2022

(30) Foreign Application Priority Data
Aug. 8, 2019 (JP) 2019-146337

(51) Int. Cl. G01C 21/00; G01C 21/30; G05D 1/02

(52) U.S. Cl. CPC G01C 21/383; G01C 21/30; G05D 1/0274; G05D 1/0246; G01C 21/3867

(57) ABSTRACT

An information processing system according to the present disclosure includes a mobile body that creates an advance map corresponding to a travel environment based on a distance measurement result by a distance measurement sensor to perform self-position estimation based on the advance map and an information processing device that arranges nodes in the advance map. The information processing device includes a receiving unit that receives a self-position estimation result of a mobile body in an advance map and a node arrangement unit that arranges nodes in the advance map based on the self-position estimation result.

### FIELD

The present disclosure relates to an information processing system, an information processing device, and an information processing method.

### BACKGROUND

In the related art, there is known a technique for an autonomous mobile body to create map information using information about a surrounding environment acquired by a mounted sensor. For example, a technology for mapping parameter data acquired by a robot mapping system is provided. For example, there is a generally known technique called simultaneous localization and mapping (SLAM) in which an environmental map is created using a laser range scanner (range measurement sensor, LIDAR), a camera, an encoder, a microphone array, and the like mounted on an autonomous mobile body, and self-position estimation is performed by matching with a landmark or the like based on the created environmental map information.

### CITATION LIST

### Patent Literature

Patent Literature 1: JP 2016-157473 A

### SUMMARY

### Technical Problem

According to the conventional technique, it is possible to estimate the self-position of the robot itself by storing information such as a landmark, holding the information as a map, and performing matching with the observation result.

However, in the prior art, distortion due to an observation error or the like exists in map data stored as a landmark, and the self-position observed by matching does not necessarily match the metrics in the real world. Therefore, in the related art, there is a problem in that it is difficult to give an accurate position corresponding to the real world when giving a position such as a destination of a mobile body such as a robot as coordinates.

Therefore, the present disclosure proposes an information processing system, an information processing device, and an information processing method capable of minimizing the influence of distortion, deviation, and the like on the advance map by referring to the created advance map and setting a destination while calculating a self-position in a coordinate system on the advance map.

### Solution to Problem

According to the present disclosure, an information processing system includes a mobile body that creates an advance map corresponding to a travel environment based on a distance measurement result by a distance measurement sensor to perform self-position estimation based on the advance map; and an information processing device that arranges a node in the advance map, wherein the information processing device comprises a receiving unit that receives a self-position estimation result of the mobile body in the advance map, and a node arrangement unit that arranges a node in the advance map based on the self-position estimation result.

### BRIEF DESCRIPTION OF DRAWINGS

FIG. 1 is a diagram illustrating an example of information processing according to the first embodiment of the present disclosure.

FIG. 2 is a diagram illustrating an example of information processing according to the first embodiment of the present disclosure.

FIG. 3 is a diagram illustrating an example of information processing according to the first embodiment of the present disclosure.

FIG. 4 is a diagram illustrating a configuration example of an information processing system according to the first embodiment.

FIG. 5 is a diagram illustrating a configuration example of an information processing device according to the first embodiment.

FIG. 6 is a diagram illustrating a configuration example of a mobile device according to the first embodiment.

FIG. 7 is a flowchart illustrating a procedure of information processing according to the first embodiment.

FIG. 8 is a flowchart illustrating a procedure of information processing according to the first embodiment.

FIG. 9 is a sequence diagram illustrating a procedure of information processing according to the first embodiment.

FIG. 10 is a diagram illustrating an example of a conceptual diagram of a configuration of an information processing system.

FIG. 11 is a diagram illustrating a configuration example of an information processing system according to the second embodiment of the present disclosure.

FIG. 12 is a diagram illustrating a configuration example of an information processing device according to the second embodiment.

FIG. 13 is a diagram illustrating a configuration example of a mobile device according to the second embodiment.

FIG. 14 is a diagram illustrating an example of information processing according to the second embodiment.

FIG. 15 is a hardware configuration diagram illustrating an example of a computer that implements functions of a mobile device and an information processing device.

### DESCRIPTION OF EMBODIMENTS

Hereinafter, the embodiments of the present disclosure will be described in detail with reference to the drawings. Note that the information processing system, the information processing device, and the information processing method according to the present application are not limited by the embodiments. In the following embodiments, the same parts are denoted by the same reference signs, and a duplicate description will be omitted.

The present disclosure will be described in the order of the following items.

1. First Embodiment

1-1. Overview of information processing according to the first embodiment of the present disclosure

1-2. Configuration of information processing system according to the first embodiment

1-3. Configuration of information processing device according to the first embodiment

1-4. Configuration of mobile device according to the first embodiment

1-5. Procedure of information processing according to the first embodiment

1-6. Conceptual diagram of configuration of information processing system

2. Second Embodiment

2-1. Configuration of information processing system according to the second embodiment of the present disclosure

2-2. Configuration of information processing device according to the second embodiment

2-3. Configuration of mobile device according to the second embodiment

2-4. Overview of information processing according to the second embodiment

3. Other embodiments

3-1. Other configuration examples

3-2. Example of mobile body

3-3. Others

4. Effects according to the present disclosure

5. Hardware configuration

### 1. First Embodiment

[1-1. Overview of Information Processing According to the First Embodiment of the Present Disclosure]

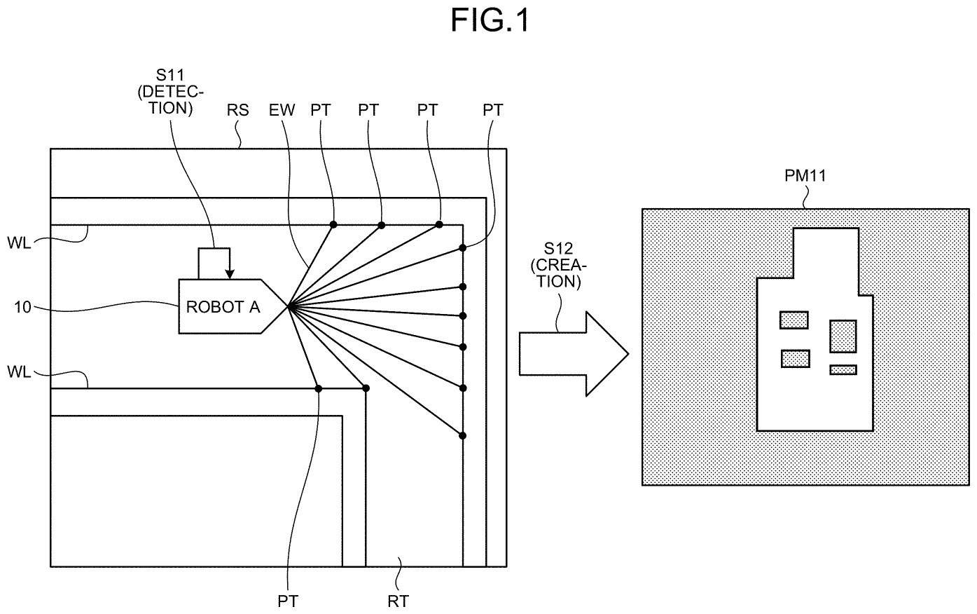

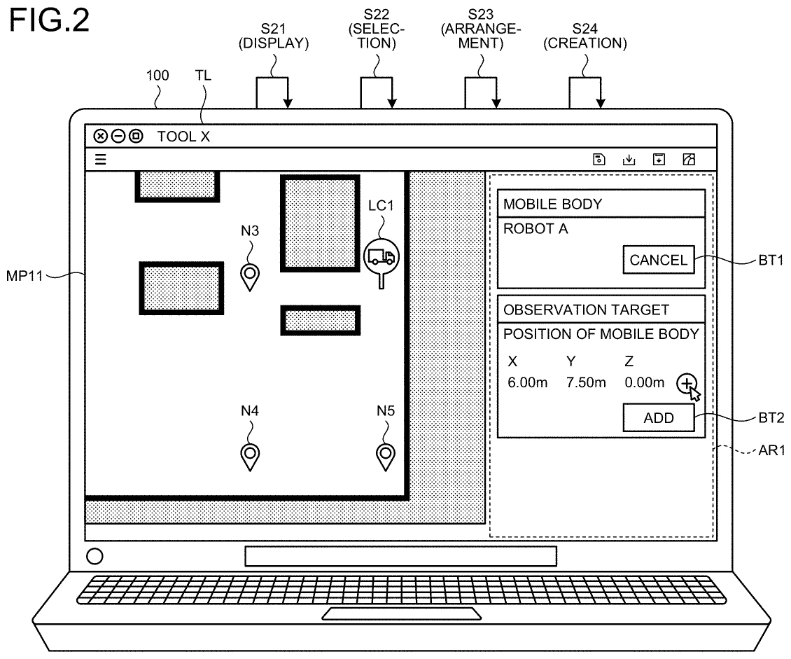

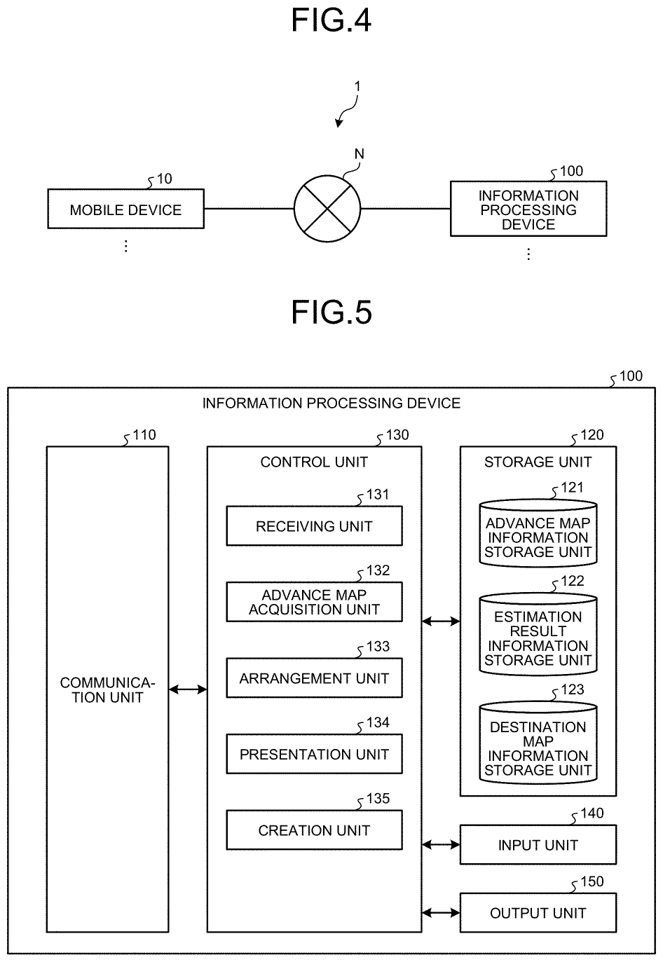

FIGS. 1 to 3 are diagrams illustrating an example of the information processing according to the first embodiment of the present disclosure. The information processing according to the first embodiment of the present disclosure is realized by an information processing system 1 (see FIG. 4) including a mobile device 10 illustrated in FIG. 1 and an information processing device 100 illustrated in FIG. 2.

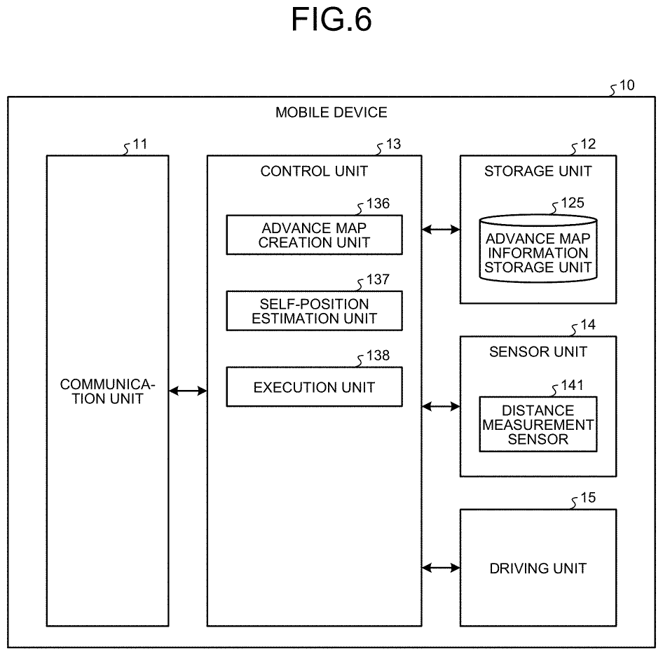

The mobile device 10 and the information processing device 100 included in the information processing system 1 execute information processing according to the first embodiment. The mobile device 10 is a robot A (information processing device) that creates an advance map corresponding to a travel environment based on a distance measurement result by a distance measurement sensor 141 (see FIG. 6) to perform self-position estimation based on the advance map. The travel environment here is a concept including a route (travel route) on which the mobile device 10 travels and an environment around the route. In addition, the advance map referred to here is, for example, a map corresponding to a place (space) where the mobile device 10 autonomously travels after the processing illustrated in FIGS. 1 to 3.

In the example of FIG. 1, an autonomous mobile robot is illustrated as an example of the mobile device 10. Note that the mobile device 10 may be various mobile bodies such as an automobile that travels by automatic driving, but this point will be described later. Furthermore, in the example of FIG. 1, a case where light detection and ranging, laser imaging detection and ranging (LiDAR) is used as an example of the distance measurement sensor 141 is illustrated. Note that the distance measurement sensor 141 is not limited to the LiDAR, and may be various sensors such as a time of flight (ToF) sensor and a stereo camera. Furthermore, the information processing device 100 arranges, in the advance map, nodes based on the self-position estimation result of the mobile body in the advance map.

First, an outline of processing of the mobile device 10 such as creation of a map (advance map) will be described with reference to FIG. 1. The example of FIGS. 1 and 2 illustrate a case where a connection between the robot A, which is the mobile device 10, and the information processing device 100 is established. The mobile device 10 performs detection by the distance measurement sensor 141 which is the LiDAR (step S11). The mobile device 10 performs detection regarding the surrounding environment by the distance measurement sensor 141. The mobile device 10 performs detection regarding a route RT on which the mobile device 10 travels by the distance measurement sensor 141. In the example of FIG. 1, the mobile device 10 detects a wall WL and the like located around the route RT by the distance measurement sensor 141. The mobile device 10 collects information about the surrounding wall WL and the like by the electromagnetic wave EW detected by the distance measurement sensor 141. The mobile device 10 collects a point group (point group information) such as a plurality of points PT in FIG. 1 by detection by the distance measurement sensor 141. The mobile device 10 collects the point group information while traveling. The mobile device 10 collects the point group information by the detection by the distance measurement sensor 141 while traveling a place where the mobile device 10 autonomously travels after the processing illustrated in FIGS. 1 to 3.

Then, the mobile device 10 creates an advance map (step S12). In the example of FIG. 1, the mobile device 10 creates an advance map PM11 using the point group information. For example, the mobile device 10 generates the advance map using a point group by the LiDAR or the like by appropriately using various techniques. The mobile device 10 generates the advance map PM11 using a technique of map creation using a point group by the LiDAR or the like. In this manner, the mobile device 10 collects the point group information while traveling, and creates the advance map of the real world. Then, the mobile device 10 transmits the created advance map PM11 to the information processing device 100. A white portion in the map such as the advance map PM11 indicates an area (region) in which no object is detected, a black portion in the map such as the advance map PM11 indicates an area (region) in which an object is detected, and a gray portion in the map such as the advance map PM11 indicates an undetected area (region). For example, a white portion in the map such as the advance map PM11 indicates a passage where an object is observed, a black portion in the map such as the advance map PM11 indicates a wall observed by a point group, and a gray portion in the map such as the advance map PM11 indicates an unobserved region. That is, a white portion in the map such as the advance map PM11 indicates an area (region) where the mobile body 10 can travel, and a black portion and a gray portion in the map such as the advance map PM11 indicate an area (region) where the mobile body 10 cannot travel.

In addition, the mobile device 10 estimates the self-position using the point group information detected at the time of actual traveling and the advance map. The mobile device 10 moves while performing self-position estimation based on the advance map. The mobile device 10 calculates the self-position by matching the point group data such as the LiDAR obtained at the time of actual traveling with the advance map. In the example of FIG. 1, the mobile device 10 detects the point group information while traveling a place corresponding to the advance map PM11, and estimates the self-position by matching the detected point group information with the advance map. Then, the mobile device 10 transmits information indicating the estimated self-position to the information processing device 100. The mobile device 10 transmits the self-position estimation result to the information processing device 100. In this manner, the mobile device 10 moves while performing self-position estimation based on the advance map to transmit information indicating the estimated self-position to the information processing device 100 in real time.

As illustrated in FIG. 2, the information processing device 100 displays various types of information received from the mobile device 10 (step S21). The information processing device 100 displays the advance map PM11 and the self-position estimation result of the mobile device 10 on a tool screen TL of a tool X. A map MP11 illustrated on the left side of the tool screen TL in FIG. 2 corresponds to a map in which part of the advance map PM11 is enlarged and displayed. In the example of FIG. 2, the information processing device 100 displays the map MP11 in which the central portion of the advance map PM11 is enlarged and displayed.

In addition, the information processing device 100 displays a pin LC1 indicating the self-position estimation result of the mobile device 10 on the map MP11. The pin LC1 indicates the current location of the mobile device 10 in the advance map PM11. The position of the pin LC1 is updated as needed in real time. The information processing device 100 displays the pin LC1 at a position on the map MP11 corresponding to the latest self-position estimation result of the mobile device 10. In addition, the information processing device 100 displays various types of information about the mobile device 10 in an area AR1 of the tool screen TL in FIG. 2. The information processing device 100 displays information indicating that the mobile body 10 to be observed is the robot A. The information processing device 100 displays information indicating the position of the robot A, which is the mobile body 10 to be observed. The information processing device 100 displays information indicating that the position of the robot A is “6 m” in X, “7.5 m” in Y, and “0 m” in Z. For example, the information processing device 100 displays information indicating that the position of the robot A is 6 m in the X-axis direction, 7.5 m in the Y-axis direction, and 0 m in the Z-axis direction from a predetermined origin. That is, the position of the pin LC1 displayed on the map MP11 corresponds to the position of the robot A of “6 m” in X, “7.5 m” in Y, and “0 m” in Z. In this manner, the information processing device 100 presents the pin LC1 indicating the self-position estimation result of the mobile device 10 and the information indicating the coordinates to the user who uses the information processing device 100.

A button BT1 on which “CANCEL” is displayed indicates a button for canceling the connection with the robot A. In a case where the user selects the button BT1, the information processing device 100 cancels the connection with the robot A. Furthermore, in a case where the connection with the robot A is cancelled, the information processing device 100 may change the display of the button BT1 to “CONNECT”. In this case, in a case where the user selects the button BT1 displayed as “CONNECT”, the information processing device 100 establishes a connection with the robot A.

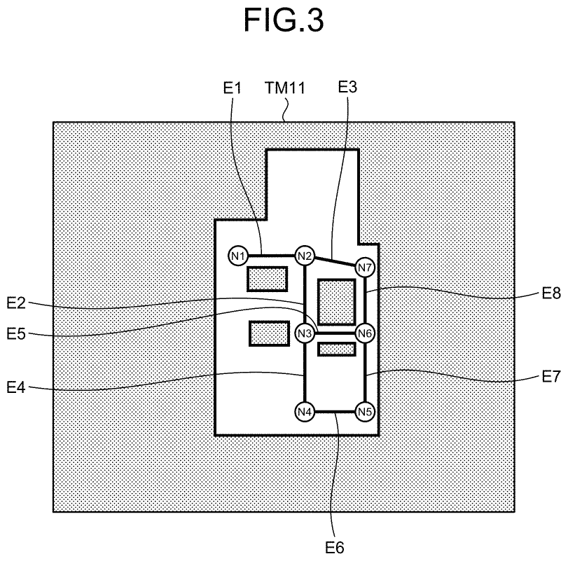

Furthermore, a button BT2 on which “ADD” is displayed indicates a button for adding a node to a position corresponding to the self-position estimation result of the mobile device 10. For example, when the user presses the button BT2, a node is arranged at the current location of the mobile device 10. In the example of FIG. 2, the button BT2 on which “ADD” is displayed indicates a button for adding a node to “6 m” in X, “7.5 m” in Y, and “0 m” in Z which is the position (current position) of the robot A. In this manner, the information processing device 100 presents various types of information used by the user to determine the arrangement of the node to the user. Note that the three nodes N3 to N5 illustrated on the map MP11 indicate nodes arranged according to selection by the user who uses the information processing device 100. Note that, respective nodes are illustrated as nodes N1 to N7 in FIGS. 2 and 3, and the coordinates indicating the position of the node, the name of the node, and the like are associated with each node.

The user selects a position where the node is to be arranged based on various types of information presented by the information processing device 100 (step S22). The user selects a position where the node is to be arranged by operating the button BT2 displayed on the information processing device 100. For example, the user operates a mouse or the like connected to the information processing device 100 and selects the button BT2 with a mouse cursor to select a position where the node is to be arranged. In the example of FIG. 2, the user selects the button BT2 in a state where the position of the robot A is presented as “6 m” in X, “7.5 m” in Y, and “0 m” in Z, thereby selecting the position where the node is to be arranged.

The information processing device 100 arranges the nodes in accordance with selection by the user (step S23). The information processing device 100 adds a new node where the position of the robot A is “6 m” in X, “7.5 m” in Y, and “0 m” in Z. The information processing device 100 adds a new node to the position where the pin LC1 is displayed on the map MP11. In the example of FIG. 2, the information processing device 100 adds a new node N6 (see FIG. 3) to the position where the pin LC1 is displayed on the map MP11. In this manner, the information processing device 100 arranges the nodes N1 to N7 (see FIG. 3) on the map MP11.

The information processing device 100 creates a destination graph (hereinafter, also referred to as a “destination map”) including an edge and a node based on the arranged nodes (step S24). In the example of FIG. 2, the information processing device 100 creates a destination map TM11 as illustrated in FIG. 3 based on the arranged nodes N1 to N7. Note that, although a map corresponding to the advance map is also illustrated in FIG. 3, the destination map TM11 may include only information about nodes and edges. For example, the destination map TM11 may be information indicating coordinates of the nodes N1 to N7 and information about the edges E1 to E8 indicating a connection relationship between the nodes. The information processing device 100 creates the destination map TM11 as illustrated in FIG. 3 by arranging the nodes N1 to N7 on the advance map PM11. The information processing device 100 creates the destination map TM11 by arranging, in the advance map PM11, the nodes N1 to N7 at positions according to selection by the user. The information processing device 100 creates the destination map TM11 in which the nodes N1 to N7 are connected by the edges E1 to E8. Here, the edge is information indicating connection between nodes. In the destination map TM11, the node N1 and the node N2 are connected by an edge E1. In the destination map TM11, the node N5 and the node N6 are connected by an edge E7. For example, the mobile device 10 may move between nodes connected by edges. For example, the mobile device 10 moves from one node to another node by following an edge.

As described above, in the information processing system 1, the information processing device 100 arranges the nodes in the advance map using the advance map created by the mobile device 10 and the estimated self-position, whereby the map information can be appropriately created according to the position of the mobile body. As described above, after creating the advance map, the information processing system 1 sets the destination while calculating the self-position using the map, thereby minimizing the influence of distortion, deviation, and the like of the advance map. The information processing system 1 reads the advance map on the tool and draws the self-position on the tool in real time, so that the user can set the destination while confirming the position in a state including the distortion of the advance map and the like.

For example, in a system that calculates a self-position by point group matching using an optical distance measurement sensor such as the LiDAR or ToF, in a case where a traveling place is determined in advance, an observation result of the traveling place is often held as an advance map. Such an advance map has some distortion when compared with the real world, but since the mobile device 10 such as a robot basically operates with coordinates on the advance map, it is not a big problem as long as the same coordinates can be always acquired at the same place. However, in a case where the nodes are arranged on the advance map based on the information observed by the robot actually traveling, and the map is updated, a problem may occur by arranging the nodes based on the coordinate system of the actual observation result (for example, the real world) different from the coordinate system of the advance map. For example, in a case where nodes are arranged in the advance map based on a coordinate system that is not the same as the coordinate system of the advance map in the advance map, there may be a case where the nodes are not arranged at desired position.

Furthermore, in a case where the “destination/waypoint” group is expressed by a node/edge as a “destination map” and used for a movement plan, a point representing the destination/waypoint is set as a “node” and a connection between nodes is set as an “edge” and arranged on the advance map. In this case, the mobile device 10 such as a robot moves on coordinates on the advance map based on a movement instruction for a node such as [move to node N3] or [move to node N6 via node N4]. In this case, the information associated with the coordinates of the destination or the like is required to be expressed by coordinates on the advance map instead of coordinates in the real world.

As described above, it is necessary to arrange the nodes on the coordinates of the advance map, but since the advance map is somewhat distorted compared to the real world, it is difficult to arrange the nodes at correct position even when the coordinates of the real world are measured. For example, when arranged according to a result of surveying a destination in the real world, there is a case where coordinates include distortion of the advance map. In this case, there may be a case where the user cannot accurately go to a desired place.

Therefore, the information processing system 1 arranges the nodes serving as the destination/waypoint while calculating the self-position using the created advance map. For example, in the information processing system 1, a mobile device 10 such as a robot is taken to an actual destination/waypoint by using a hand, a remote controller, or the like, and a node is hit at the calculated self-position.

For example, there is distortion between the advance map by an optical distance measurement sensor such as the LiDAR or ToF and the real world, and even when distance measurement is performed in the real world, for example, there is a case where it is not given as a correct destination on the advance map. Therefore, the information processing system 1 arranges the destination in advance while performing self-position estimation using the advance map using the self-position estimation technology using the point group matching by the optical distance measurement sensor such as the LiDAR or ToF as described above. Specifically, in the information processing system 1, the tool (information processing device 100) communicates with the actual robot (mobile device 10) to arrange the destination (node) while actually moving the robot while confirming the current self-position on the screen. As a result, the information processing system 1 can accurately provide the destination of the mobile device 10 such as a robot in accordance with the real world. In the information processing system 1, the robot can autonomously move in a severe environment requiring more accuracy.

[1-2. Configuration of Information Processing System According to the First Embodiment]

The information processing system 1 illustrated in FIG. 4 will be described. FIG. 4 is a diagram illustrating a configuration example of the information processing system according to the first embodiment. As illustrated in FIG. 4, the information processing system 1 includes the mobile device 10 and the information processing device 100. The mobile device 10 and the information processing device 100 are communicably connected in a wired or wireless manner via a network N. Note that the information processing system 1 illustrated in FIG. 4 may include the plurality of mobile devices 10 and the plurality of information processing devices 100.

The mobile device 10 creates an advance map corresponding to the travel environment based on the distance measurement result by the distance measurement sensor to perform self-position estimation based on the advance map. The mobile device 10 moves while performing self-position estimation based on the advance map. In the example of FIG. 1, the mobile device 10 is an autonomous mobile robot, but the mobile device 10 may be various mobile bodies such as a vehicle. That is, the mobile device 10 is not limited to the autonomous mobile robot as long as it can transmit and receive information to and from the information processing device 100, and may be various mobile bodies such as an automobile and a drone that travel by automatic driving. The mobile device 10 may be any device as long as the processing in the embodiment can be realized.

The mobile device 10 transmits information about the advance map to the information processing device 100. The mobile device 10 transmits the created advance map to the information processing device 100. As a result, the information processing device 100 acquires the advance map. Furthermore, the mobile device 10 may transmit the sensor information detected by a sensor unit 14 to the information processing device 100. In this case, the mobile device 10 transmits sensor information detected by a sensor such as the distance measurement sensor 141 to the information processing device 100. The mobile device 10 transmits distance information between the object to be measured by the distance measurement sensor 141 and the distance measurement sensor to the information processing device 100. As a result, the information processing device 100 acquires distance information between the object to be measured by the distance measurement sensor 141 and the distance measurement sensor.

The information processing device 100 is an information processing device used by a user. The information processing device 100 may communicate with the mobile device 10 via the network N and give an instruction to control the mobile device 10 based on information collected by the mobile device 10 and various sensors. The information processing device 100 may be any device as long as the processing in the embodiment can be realized. The information processing device 100 may be any device as long as it has a configuration including a display (output unit 150) that displays information. Furthermore, the information processing device 100 may be, for example, a device such as a smartphone, a tablet terminal, a notebook personal computer (PC), a desktop PC, a cellular phone, or a personal digital assistant (PDA). In the example of FIG. 2, the information processing device 100 is a notebook PC used by a user such as an operator who operates the mobile device 10.

Note that the information processing device 100 may receive a user's operation by voice. The information processing device 100 may include a sound sensor (microphone) that detects sound. In this case, the information processing device 100 detects the utterance of the user by the sound sensor. The information processing device 100 may include software modules such as a voice signal process, a voice recognition, an utterance semantic analysis, interaction control, and an action output.

The information processing device 100 is used to provide a service related to map creation. The information processing device 100 performs various types of information processes regarding map creation for the user. The information processing device 100 is a computer that arranges nodes in the advance map. The information processing device 100 is a computer that receives a self-position estimation result of the mobile device 10 in the advance map to arrange nodes in the advance map based on the self-position estimation result.

[1-3. Configuration of Information Processing Device According to the First Embodiment]

Next, a configuration of an information processing device 100 that is an example of an information processing device that executes information processing according to an embodiment will be described. FIG. 5 is a diagram illustrating a configuration example of the information processing device according to the first embodiment.

As illustrated in FIG. 5, the information processing device 100 includes a communication unit 110, a storage unit 120, a control unit 130, an input unit 140, and an output unit 150.

The communication unit 110 is realized by, for example, a network interface card (NIC) or the like. Then, the communication unit 110 is connected to the network N (see FIG. 4) in a wired or wireless manner to transmit and receives information to and from another information processing device such as the mobile device 10. Furthermore, the communication unit 110 transmits and receives information to and from the mobile device 10.

For example, the storage unit 120 is realized by a semiconductor memory device such as a random access memory (RAM) and a flash memory, or a storage device such as a hard disk and an optical disk. The storage unit 120 according to the embodiment includes an advance map information storage unit 121, an estimation result information storage unit 122, and a destination map information storage unit 123.

The advance map information storage unit 121 stores various types of information about a map. The advance map information storage unit 121 stores an advance map based on information detected by the mobile device 10. For example, the advance map information storage unit 121 stores a two-dimensional advance map. For example, the advance map information storage unit 121 stores information such as the advance map PM11. For example, the advance map information storage unit 121 may store a three-dimensional advance map. For example, the advance map information storage unit 121 may store an occupied grid map.

The estimation result information storage unit 122 stores various types of information about the estimation result. The estimation result information storage unit 122 stores information about the self-position estimation by the mobile device 10. The estimation result information storage unit 122 stores information indicating the self-position estimated by the mobile device 10.

The destination map information storage unit 123 stores various types of information about the destination map. The destination map information storage unit 123 stores information about a destination map based on the arranged nodes. The destination map information storage unit 123 stores information such as the destination map TM11.

The control unit 130 is implemented by, for example, a central processing unit (CPU), a micro processing unit (MPU), or the like executing a program (for example, an information processing program or the like according to the present disclosure) stored inside the information processing device 100 using a RAM or the like as a work area. The control unit 130 is a controller, and is realized by an integrated circuit such as an application specific integrated circuit (ASIC) or a field programmable gate array (FPGA).

As illustrated in FIG. 5, the control unit 130 includes a receiving unit 131, an advance map acquisition unit 132, an arrangement unit 133, a presentation unit 134, and a creation unit 135, and implements or executes a function and an action of information processing described below. Note that the internal configuration of the control unit 130 is not limited to the configuration illustrated in FIG. 5, and may be another configuration as long as information processing to be described later is performed. Furthermore, the connection relationship between the processing units included in the control unit 130 is not limited to the connection relationship illustrated in FIG. 5, and may be another connection relationship.

The receiving unit 131 receives various types of information. The receiving unit 131 receives various types of information from an external information processing device. The receiving unit 131 receives various types of information from another information processing device such as the mobile device 10. In the example of FIG. 2, the receiving unit 131 receives the advance map PM11 from the mobile device 10. The receiving unit 131 receives the self-position estimation result of the mobile device 10 in the advance map. The receiving unit 131 receives information indicating the self-position from the mobile device 10. The receiving unit 131 receives the self-position estimation result from the mobile device 10.

The advance map acquisition unit 132 acquires various types of information. The advance map acquisition unit 132 acquires various types of information from an external information processing device. The advance map acquisition unit 132 acquires various types of information from the mobile device 10. The advance map acquisition unit 132 acquires various types of information from another information processing device such as a voice recognition server.

The advance map acquisition unit 132 acquires various types of information from the storage unit 120. The advance map acquisition unit 132 acquires various types of information from the advance map information storage unit 121, the estimation result information storage unit 122, and the destination map information storage unit 123.

The advance map acquisition unit 132 acquires various types of information generated by the creation unit 135. The advance map acquisition unit 132 acquires various types of information generated by the creation unit 135. The advance map acquisition unit 132 acquires various types of information determined by the arrangement unit 133.

The advance map acquisition unit 132 acquires an advance map of a travel environment of the mobile device 10. The advance map acquisition unit 132 acquires the advance map from the advance map information storage unit 121. The advance map acquisition unit 132 acquires the advance map from the mobile device 10.

The arrangement unit 133 arranges various types of information. The arrangement unit 133 determines various types of information. The arrangement unit 133 performs various determinations. For example, the arrangement unit 133 determines various types of information based on information from an external information processing device or information stored in the storage unit 120. The arrangement unit 133 determines various types of information based on information from another information processing device such as the mobile device 10. The arrangement unit 133 determines various types of information based on information stored in the advance map information storage unit 121, the estimation result information storage unit 122, or the destination map information storage unit 123.

The arrangement unit 133 determines various types of information based on the various types of information acquired by the acquisition unit 131. The arrangement unit 133 determines various types of information based on the various types of information generated by the creation unit 135. The arrangement unit 133 makes various determinations based on the determination. The arrangement unit 133 makes various determinations based on the information acquired by the acquisition unit 131.

The arrangement unit 133 arranges nodes in the advance map. The arrangement unit 133 arranges nodes in the advance map based on the self-position estimation result. The arrangement unit 133 arranges the nodes at the position on the advance map based on the self-position estimation result of the mobile device 10 indicating a position on the advance map. The arrangement unit 133 arranges the nodes at the coordinates on the advance map based on the self-position estimation result of the mobile device 10 indicating the coordinates on the advance map.

The arrangement unit 133 arranges the nodes according to selection by the user. The arrangement unit 133 arranges the nodes according to selection by the user to which the self-position estimation result is presented by the presentation unit 134. The arrangement unit 133 arranges the nodes according to selection by the user with respect to the self-position estimation result displayed on the screen (output unit 150). The arrangement unit 133 arranges the nodes in accordance with the operation of the button by the user.

In the example of FIG. 2, the arrangement unit 133 adds a new node to the position of the robot A at “6 m” in X, “7.5 m” in Y, and “0 m” in Z. The arrangement unit 133 adds a new node to the position where the pin LC1 is displayed on the map MP11. The arrangement unit 133 adds a new node N6 (see FIG. 3) to the position where the pin LC1 is displayed on the map MP11. The arrangement unit 133 arranges the nodes N1 to N7 (see FIG. 3) on the map MP11.

The presentation unit 134 presents various types of information. The presentation unit 134 presents various types of information by causing the output unit 150 to display various types of information. The presentation unit 134 presents the advance map PM11 by causing the output unit 150 to display the advance map PM11. Presentation unit 134 presents destination map TM11 by causing the output unit 150 to display the destination map TM11. For example, the presentation unit 134 presents various types of information based on information from an external information processing device or information stored in the storage unit 120. The presentation unit 134 presents various types of information based on information from another information processing device such as the mobile device 10. The presentation unit 134 presents various types of information based on information stored in the advance map information storage unit 121, the estimation result information storage unit 122, or the destination map information storage unit 123.

The presentation unit 134 generates various types of information such as a screen (image information) to be displayed on the output unit 150 by appropriately using various technologies. The presentation unit 134 generates a screen (image information) or the like to be displayed on the output unit 150. For example, the presentation unit 134 generates a screen (image information) or the like to be displayed on the output unit 150 based on the information stored in the storage unit 120. In the example of FIG. 1, the presentation unit 134 generates content including a map screen, the buttons BT1 and BT2, and the like displayed on the tool screen TL of the tool X. The presentation unit 134 may generate a screen (image information) or the like by any processing as long as the screen (image information) or the like to be displayed on the output unit 150 can be generated. For example, the presentation unit 134 generates a screen (image information) to be displayed on the output unit 150 by appropriately using various technologies related to an image generation, an image processing, and the like. For example, the presentation unit 134 generates a screen (image information) to be displayed on the output unit 150 by appropriately using various technologies such as Java (registered trademark). Note that the presentation unit 134 may generate a screen (image information) to be displayed on the output unit 150 based on a format such as CSS, JavaScript (registered trademark), or HTML. Furthermore, for example, the presentation unit 134 may generate a screen (image information) in various formats such as a joint photographic experts group (JPEG), a graphics interchange format (GIF), and portable network graphics (PNG).

The presentation unit 134 presents various types of information by transmitting various types of information to an external information processing device. The presentation unit 134 provides various types of information to an external information processing device. The presentation unit 134 transmits various types of information to an external information processing device. For example, the presentation unit 134 transmits various types of information to another information processing device such as the mobile device 10. The presentation unit 134 provides the information stored in the storage unit 120. Presentation unit 134 transmits the information stored in the storage unit 120. The presentation unit 134 transmits to the mobile device 10 an instruction to move the mobile device 10. The presentation unit 134 transmits to the mobile device 10 an instruction to move the mobile device 10 according to the operation of the user.

The presentation unit 134 provides various types of information based on information from another information processing device such as the mobile device 10. The presentation unit 134 provides various types of information based on the information stored in the storage unit 120. The presentation unit 134 provides various types of information based on information stored in the advance map information storage unit 121, the estimation result information storage unit 122, or the destination map information storage unit 123.

The presentation unit 134 presents the self-position estimation result to the user. The presentation unit 134 displays the self-position estimation result on the screen (output unit 150).

In the example of FIG. 2, the presentation unit 134 displays various types of information received from the mobile device 10. The presentation unit 134 displays the advance map PM11 and the self-position estimation result of the mobile device 10 on the tool screen TL of the tool X. The presentation unit 134 displays a map MP11 in which the central portion of the advance map PM11 is enlarged and displayed.

The presentation unit 134 displays the pin LC1 indicating the self-position estimation result of the mobile device 10 on the map MP11. The presentation unit 134 displays the pin LC1 at a position on the map MP11 corresponding to the latest self-position estimation result of the mobile device 10. In addition, the presentation unit 134 displays various types of information about the mobile device 10 in the area AR1 of the tool screen TL in FIG. 2. The presentation unit 134 displays information indicating that the mobile body 10 to be observed is the robot A. The presentation unit 134 displays information indicating the position of the robot A, which is the mobile body 10 to be observed. The presentation unit 134 displays information indicating that the position of the robot A is “6 m” in X, “7.5 m” in Y, and “0 m” in Z. For example, the presentation unit 134 displays information indicating that the position of the robot A is 6 m in the X-axis direction, 7.5 m in the Y-axis direction, and 0 m in the Z-axis direction from a predetermined origin. The presentation unit 134 presents the pin LC1 indicating the self-position estimation result of the mobile device 10 and the information indicating the coordinates to the user who uses the information processing device 100.

The creation unit 135 creates various types of information. The creation unit 135 generates various types of information. The creation unit 135 generates various types of information based on information from an external information processing device or information stored in the storage unit 120. The creation unit 135 generates various types of information based on information from another information processing device such as the mobile device 10. The creation unit 135 generates various types of information based on information stored in the advance map information storage unit 121, the estimation result information storage unit 122, or the destination map information storage unit 123. The creation unit 135 generates a destination map. The creation unit 135 may generate the advance map.

The creation unit 135 generates various types of information based on the various types of information acquired by the acquisition unit 131. The creation unit 135 generates various types of information based on the various types of information arranged by the arrangement unit 133.

The creation unit 135 creates a destination map based on the nodes arranged by the arrangement unit 133.

In the example of FIG. 2, the creation unit 135 creates the destination map TM11 as illustrated in FIG. 3 based on the arranged nodes N1 to N7. The creation unit 135 creates the destination map TM11 as illustrated in FIG. 3 by arranging the nodes N1 to N7 in the advance map PM11. The creation unit 135 creates the destination map TM11 by arranging, in the advance map PM11, the nodes N1 to N7 at positions according to selection by the user. The creation unit 135 creates the destination map TM11 in which the nodes N1 to N7 are connected by the edges E1 to E8.

Various operations are input from the user to the input unit 140. The input unit 140 receives various operations from a keyboard provided in the information processing device 100 or a mouse connected to the information processing device 100. The input unit 140 may have a keyboard or a mouse connected to the information processing device 100. Furthermore, the input unit 140 may include a button provided in the information processing device 100 or a microphone that detects a voice. The input unit 140 may have a function of detecting a voice.

For example, the input unit 140 may have a touch panel capable of realizing functions equivalent to those of a keyboard and a mouse. In this case, various types of information are input to the input unit 140 via the display (output unit 150). The input unit 140 receives various operations from the user via the display screen by a function of a touch panel realized by various sensors. That is, the input unit 140 receives various operations from the user via the output unit 150 of the information processing device 100. For example, the input unit 140 receives an operation such as a node arrangement operation by the user via the output unit 150 of the information processing device 100. For example, the input unit 140 functions as a reception unit that receives a user's operation by the function of the touch panel. Note that, as a method of detecting the user's operation by the input unit 140, an electrostatic capacitance method is mainly used in the tablet terminal, but any method may be used as long as the user's operation can be detected and the function of the touch panel can be realized, such as a resistive film method, a surface acoustic wave method, an infrared method, and an electromagnetic induction method, which are other detection methods.

The output unit 150 is a display screen of a tablet terminal or the like realized by, for example, a liquid crystal display, an organic electro-luminescence (EL) display, or the like, and is a display device that displays various types of information.

[1-4. Configuration of Mobile Device According to the First Embodiment]

Next, a configuration of the mobile device 10, which is an example of a mobile body that executes information processing according to the first embodiment, will be described. FIG. 6 is a diagram illustrating a configuration example of the mobile device 10 according to the first embodiment.

As illustrated in FIG. 6, the mobile device 10 includes a communication unit 11, a storage unit 12, a control unit 13, a sensor unit 14, and a driving unit 15.

The communication unit 11 is realized by, for example, an NIC, a communication circuit, or the like. The communication unit 11 is connected to a network N (the Internet or the like) in a wired or wireless manner to transmit and receives information to and from other devices and the like via the network N.

The storage unit 12 is realized by, for example, a semiconductor memory device such as a RAM or a flash memory, or a storage device such as a hard disk or an optical disk. The storage unit 12 includes an advance map information storage unit 125.

The advance map information storage unit 125 stores various types of information about a map. The advance map information storage unit 125 stores various types of information about the obstacle map. For example, the advance map information storage unit 125 stores a two-dimensional advance map. For example, the advance map information storage unit 125 stores information such as the advance map PM11. For example, the advance map information storage unit 125 may store a three-dimensional advance map. For example, the advance map information storage unit 125 may store an occupied grid map.

Note that the storage unit 12 is not limited to the advance map information storage unit 125, and various types of information may be stored. The storage unit 12 stores a destination map. The storage unit 12 may include a destination map storage unit (not illustrated) that stores a destination map. In addition, the storage unit 12 stores position information about an object detected by the distance measurement sensor 141. For example, the storage unit 12 stores position information about an obstacle such as a wall. For example, the storage unit 12 may store position information and shape information about a reflective obstacle such as a mirror. For example, in a case where the information about the reflective obstacle has been acquired in advance, the storage unit 12 may store the position information and the shape information about the reflective obstacle and the like. For example, the storage unit 12 may detect a reflective obstacle using a camera and store the position information and the shape information about the detected reflective obstacle and the like.

Returning to FIG. 6, the description will be continued. The control unit 13 is implemented by, for example, a CPU, an MPU, or the like executing a program (for example, an information processing program according to the present disclosure) stored inside the mobile device 10 using a RAM or the like as a work area. The control unit 13 may be realized by, for example, an integrated circuit such as an ASIC or an FPGA.

As illustrated in FIG. 6, the control unit 13 includes an advance map creation unit 136, a self-position estimation unit 137, and an execution unit 138, and realizes or executes a function and an action of information processing described below. Note that the internal configuration of the control unit 13 is not limited to the configuration illustrated in FIG. 6, and may be another configuration as long as information processing to be described later is performed.

The advance map creation unit 136 performs various types of generation. The advance map creation unit 136 creates (generates) various types of information. The advance map creation unit 136 creates various types of information using various types of sensor information detected by the sensor unit 14. The advance map creation unit 136 acquires information from the storage unit 12 and generates various types of information based on the acquired information. The advance map creation unit 136 generates various types of information based on the information stored in the storage unit 12. The advance map creation unit 136 generates map information. The advance map creation unit 136 stores the generated information in the storage unit 12. The advance map creation unit 136 creates the advance map using various technologies related to map generation.

The advance map creation unit 136 creates an advance map corresponding to the travel environment based on the distance measurement result by the distance measurement sensor 141. The advance map creation unit 136 creates the advance map based on the distance measurement result by the distance measurement sensor 141 mounted on the mobile device 10. The advance map creation unit 136 creates the advance map in accordance with a movement of the mobile device 10 in the travel environment.

In the example of FIG. 1, the advance map creation unit 136 creates the advance map PM11 using the point group information. The advance map creation unit 136 generates an advance map using a point group by the LiDAR or the like by appropriately using various techniques. The advance map creation unit 136 generates the advance map PM11 using a technique of creating a map using a point group by the LiDAR or the like.

The self-position estimation unit 137 performs various estimations. The self-position estimation unit 137 estimates the self-position. The self-position estimation unit 137 generates information indicating the estimated self-position. The self-position estimation unit 137 acquires information from the storage unit 12 to perform various estimations based on the acquired information. The self-position estimation unit 137 performs various estimations using the map information generated by the advance map creation unit 136. The self-position estimation unit 137 performs self-position estimation using various techniques related to self-position estimation.

The self-position estimation unit 137 performs self-position estimation based on map information. The self-position estimation unit 137 estimates the self-position based on the advance map created by the advance map creation unit 136.

In the example of FIG. 1, the self-position estimation unit 137 estimates the self-position using the point group information detected at the time of actual traveling and the advance map. The self-position estimation unit 137 calculates the self-position by matching the point group data such as the LiDAR obtained during actual traveling with the advance map. The self-position estimation unit 137 detects the point group information while traveling a place corresponding to the advance map PM11, and estimates the self-position by matching the detected point group information with the advance map.

The execution unit 138 executes various types of information. The execution unit 138 executes various processes based on information from an external information processing device. The execution unit 138 executes various processes based on the information stored in the storage unit 12. The execution unit 138 executes various types of information based on the information stored in the advance map information storage unit 125. The execution unit 138 acquires information from the storage unit 12 and determines various types of information based on the acquired information.

The execution unit 138 executes transmission and reception of various types of information. The execution unit 138 receives various types of information. The execution unit 138 transmits various types of information. The execution unit 138 receives various types of information via the communication unit 11. The execution unit 138 transmits various types of information via the communication unit 11. The execution unit 138 receives various types of information from the information processing device 100. The execution unit 138 transmits various types of information to the information processing device 100. The execution unit 138 transmits information indicating the self-position estimated by the self-position estimation unit 137 to the information processing device 100.

The execution unit 138 executes various processing based on the advance map created by the advance map creation unit 136. The execution unit 138 executes various processing based on the self-position estimated by the self-position estimation unit 137. The execution unit 138 executes processing related to an action based on the information about the self-position generated by the self-position estimation unit 137. The execution unit 138 controls the driving unit 15 based on the self-position information generated by the self-position estimation unit 137 to execute an action corresponding to the self-position. The execution unit 138 executes the movement process of the mobile device 10 along the self-position under the control of the driving unit 15 based on the self-position information. The execution unit 138 executes the movement process of the mobile device 10 according to the self-position estimation based on the advance map by the self-position estimation unit 137. The execution unit 138 executes the movement process of the mobile device 10 in response to an instruction from the information processing device 100.

The sensor unit 14 detects predetermined information. The sensor unit 14 includes the distance measurement sensor 141.

The distance measurement sensor 141 is an optical distance measurement sensor. For example, the distance measurement sensor 141 detects an electromagnetic wave (for example, light) having a frequency in a predetermined range. The distance measurement sensor 141 detects a distance between the object to be measured and the distance measurement sensor 141. The distance measurement sensor 141 detects distance information between the object to be measured and the distance measurement sensor 141. In the example of FIG. 1, the distance measurement sensor 141 is the LiDAR. The LiDAR detects a distance and a relative speed to an object in its periphery by irradiating the object with a laser beam such as an infrared laser and measuring the time until the laser beam is reflected and returned. Furthermore, the distance measurement sensor 141 may be a distance measurement sensor using a millimeter wave radar. Note that the distance measurement sensor 141 is not limited to the LiDAR, and may be various sensors such as a ToF sensor and a stereo camera.

Furthermore, the sensor unit 14 is not limited to the distance measurement sensor 141, and may include various types of sensors. The sensor unit 14 may include a sensor as an imaging unit that captures an image. The sensor unit 14 has a function of an image sensor and detects image information. The sensor unit 14 may include a sensor (position sensor) that detects position information about the mobile device 10 such as a global positioning system (GPS) sensor. Note that the sensor unit 14 is not limited to the above, and may include various types of sensors. The sensor unit 14 may include various sensors such as an acceleration sensor and a gyro sensor. In addition, the sensors that detect the various types of information in the sensor unit 14 may be a common sensor or may be realized by different sensors.

The driving unit 15 has a function of driving a physical configuration in the mobile device 10. The driving unit 15 has a function of moving the position of the mobile device 10. The driving unit 15 is, for example, an actuator. Note that the driving unit 15 may have any configuration as long as the mobile device 10 can realize a desired operation. The driving unit 15 may have any configuration as long as it can realize a movement of the position of the mobile device 10 and the like. In a case where the mobile device 10 includes a movement mechanism such as a caterpillar or a tire, the driving unit 15 drives the caterpillar, the tire, or the like. For example, the driving unit 15 drives the movement mechanism of the mobile device 10 in accordance with an instruction from the execution unit 138 to move the mobile device 10 and change the position of the mobile device 10.

[1-5. Procedure of Information Processing According to the First Embodiment]

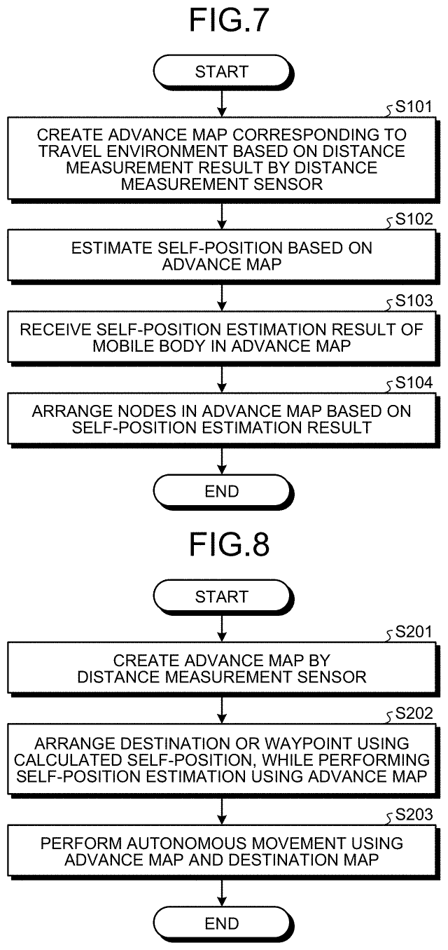

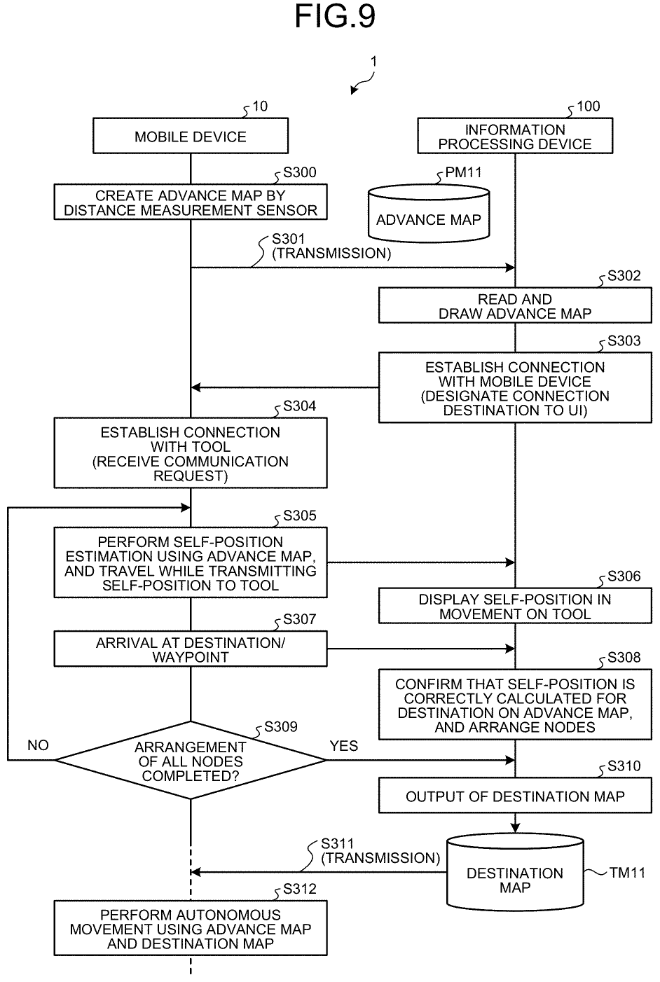

Next, a procedure of information processing according to the first embodiment will be described with reference to FIGS. 7 to 9. FIGS. 7 and 8 are flowcharts illustrating a procedure of information processing according to the first embodiment. FIG. 9 is a sequence diagram illustrating a procedure of information processing according to the first embodiment. First, a flow of a node arrangement process according to the first embodiment will be described with reference to FIG. 7. Note that the processing of each step in FIGS. 7 and 8 may be performed by any device included in the information processing system 1, such as the information processing device 100 and the mobile device 10.

As illustrated in FIG. 7, the information processing system 1 creates an advance map corresponding to the travel environment based on the distance measurement result by the distance measurement sensor 141 (step S101). For example, the mobile device 10 creates an advance map corresponding to the travel environment based on the distance measurement result by the distance measurement sensor 141.

The information processing system 1 estimates the self-position based on the advance map (step S102). For example, the mobile device 10 estimates the self-position based on the advance map.

Then, the information processing system 1 receives the self-position estimation result of the mobile body in the advance map (step S103). For example, the information processing device 100 receives the self-position estimation result of the mobile body in the advance map from the mobile device 10.

Then, the information processing system 1 arranges nodes in the advance map based on the self-position estimation result (step S104). For example, the information processing device 100 arranges the nodes in the advance map based on the self-position estimation result of the mobile device 10. The information processing device 100 acquires the advance map from the advance map information storage unit 121 to arrange the nodes in the acquired advance map.

Next, a flow of a process up to an autonomous movement according to the first embodiment will be described with reference to FIG. 8.

As illustrated in FIG. 8, the information processing system 1 creates an advance map by the distance measurement sensor 141 (step S201). For example, the mobile device 10 creates an advance map based on a distance measurement result by the distance measurement sensor 141. The mobile device 10 creates an advance map by the LiDAR or the like.

Then, while performing self-position estimation using the advance map, the information processing system 1 arranges the destination or the waypoint using the calculated self-position (step S202). For example, the mobile device 10 performs self-position estimation using the advance map. Furthermore, the information processing device 100 creates a destination map by arranging the destination or the waypoint using the self-position calculated by the mobile device 10.

Then, the information processing system 1 performs an autonomous movement using the advance map and the destination map (step S202). For example, the mobile device 10 acquires a destination map from the information processing device 100 to perform an autonomous movement using the advance map and the destination map.

Next, a flow of a process up to the autonomous movement including communication between the mobile device (actual robot) and the information processing device (tool) according to the first embodiment will be described with reference to FIG. 9. Note that, as described later, in a case where the mobile device (actual robot) and the information processing device (tool) are integrated, communication described later is performed in the same device.

As illustrated in FIG. 9, the mobile device 10 creates an advance map by a distance measurement sensor (step S300). The mobile device 10 transmits information to the information processing device 100 (step S301). For example, the mobile device 10 transmits the advance map PM11 to the information processing device 100. As a result, the information processing device 100 imports the advance map.

Then, the information processing device 100 reads and draws the advance map (step S302). For example, the information processing device 100 displays the read advance map PM11.

The information processing device 100 establishes connection with the mobile device 10 (step S303). For example, the information processing device 100 establishes connection with the actual robot. For example, the information processing device 100 establishes connection with the mobile device 10 by causing the user to designate a connection destination with a predetermined user interface (UI) or the like. For example, the information processing device 100 causes the user to designate the mobile device 10 to be the connection destination by displaying the mobile device 10 connectable to the area AR1 of the tool screen TL.

The mobile device 10 establishes a connection with the tool (step S304). The mobile device 10 receives the communication request and establishes a connection with the information processing device 100. For example, the mobile device 10 establishes a connection with the tool X installed in the information processing device 100.

The mobile device 10 performs self-position estimation using the advance map, and travels while transmitting the self-position to the tool (step S305). For example, the mobile device 10 travels by a user's hand, operation of a remote controller, or the like, performs self-position estimation using the advance map to transmit the self-position to the tool. The mobile device 10 performs real-time transmission of the self-position.

Then, the information processing device 100 displays the self-position being moved on the tool (step S306). The mobile device 10 arrives at the destination or the waypoint (step S307).

The information processing device 100 confirms that the self-position has been correctly calculated for the destination on the advance map to arrange the nodes (step S308). The information processing device 100 causes the user to confirm that the self-position has been correctly calculated for the destination on the advance map to arrange the nodes by pressing a button by the user.

In a case where the arrangement of all the nodes has not been completed (step S309: No), returning to step S305, the mobile device 10 repeats the processing for the necessary number of nodes.

In a case where the arrangement of all the nodes has been completed (step S309: Yes), the information processing device 100 outputs a destination map (step S310). For example, in a case where the user performs a predetermined operation, the information processing device 100 may determine that the arrangement of all the nodes has been completed. In a case where the arrangement of all the nodes has been completed, the mobile device 10 may notify the information processing device 100 of the completion of the arrangement of the nodes. In this case, the information processing device 100 that has received the notification outputs the destination map. The information processing device 100 outputs the destination map TM11. The information processing device 100 generates the destination map TM11 by arranging nodes in a coordinate system on the advance map PM11.

Then, the information processing device 100 transmits the destination map TM11 to the mobile device 10 (step S311). As a result, the mobile device 10 imports the destination map. Note that the mobile device 10 in step S311 and the mobile device 10 in steps S300 to S309 may be separate devices. That is, the mobile device 10 used for arrangement of nodes and the mobile device 10 that imports the destination map may be separate devices.

Then, the mobile device 10 performs an autonomous movement using the advance map and the destination map (step S312). For example, the mobile device 10 acquires a destination map from the information processing device 100 to perform an autonomous movement using the advance map and the destination map. For example, the mobile device 10 performs self-position estimation based on the advance map, and moves according to a movement route based on the destination map. For example, in a case where the mobile device 10 plans to move from the node N1 to the node N2 of the destination map TM11, the mobile device performs self-position estimation based on the advance map PM11, and executes a movement process from a position (coordinates) corresponding to the node N1 to a position (coordinates) corresponding to the node N2.

[1-6. Schematic Diagram of Configuration of Information Processing System]

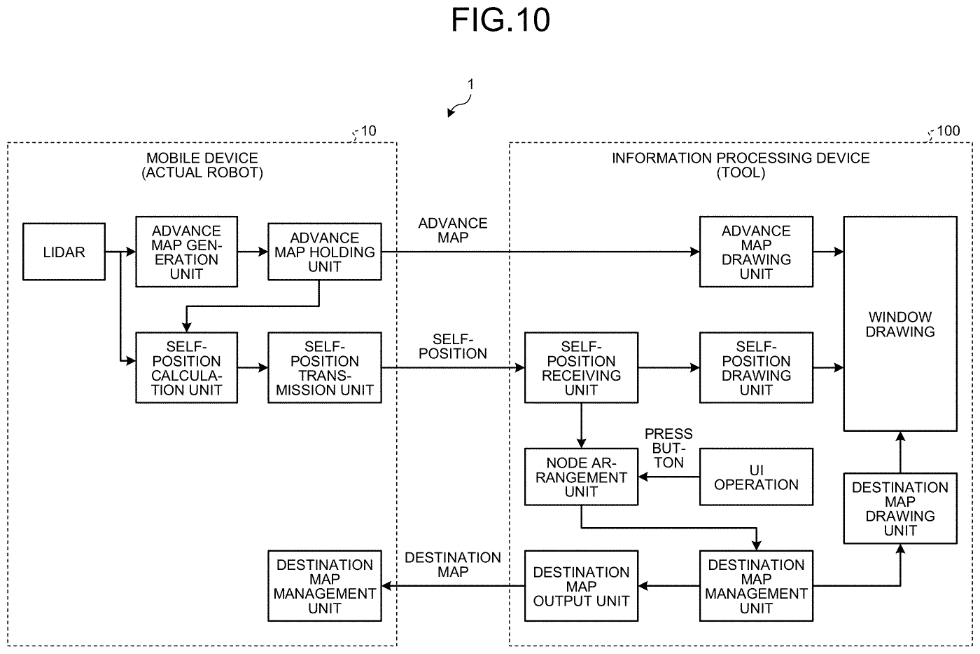

Here, each function, a hardware configuration, and data in the information processing device 100 and the mobile device 10 of the information processing system 1 are conceptually illustrated using FIG. 10. FIG. 10 is a diagram illustrating an example of a conceptual diagram of a configuration of an information processing system.

The mobile device 10, which is an actual robot illustrated in FIG. 10, includes the LIDAR, the advance map generation unit, the advance map holding unit, the self-position calculation unit, the self-position transmission unit, and the destination map management unit. For example, the LIDAR corresponds to the distance measurement sensor 141. The advance map generation unit corresponds to the advance map creation unit 136. The advance map holding unit corresponds to the advance map information storage unit 125. The advance map stored in the advance map holding unit is transmitted to the tool. The self-position calculation unit corresponds to the self-position estimation unit 137. The self-position transmission unit corresponds to the execution unit 138 and the communication unit 11. The self-position transmission unit transmits the self-position to the tool. The destination map management unit corresponds to the destination map storage unit (not illustrated) of the storage unit 12.

The information processing device 100 on which the tool illustrated in FIG. 10 is mounted includes a window drawing, an advance map drawing unit, a self-position drawing unit, a destination map drawing unit, a self-position receiving unit, a UI operation, a node arrangement unit, a destination map management unit, and a destination map output unit. The window drawing, the advance map drawing unit, the self-position drawing unit, and the destination map drawing unit correspond to the presentation unit 134 and the output unit 150. The self-position receiving unit corresponds to the receiving unit 131. The self-position receiving unit may include processing such as averaging since flutter or the like occurs depending on a self-position calculation algorithm. The UI operation corresponds to the input unit 140. The node arrangement unit corresponds to the arrangement unit 133. The destination map management unit corresponds to the destination map information storage unit 123. The destination map output unit corresponds to the presentation unit 134. The destination map output unit transmits the destination map to the mobile device 10.

### 2. Second Embodiment

In the first embodiment, the example in which the nodes are arranged on the map is described, but the object arranged on the map is not limited to the nodes, and may be various objects. For example, the information processing system may arrange an object existing in a physical space corresponding to a map on the map. For example, the information processing system may detect an object existing in a physical space corresponding to a map using an imaging unit such as a camera. In the second embodiment, a case where an object is detected using an imaging unit such as a camera and the detected object is arranged on a map will be described as an example. Note that description similar to that of the mobile device 10 and the information processing device 100 in the information processing system 1 according to the first embodiment will be omitted as appropriate.

[2-1. Configuration of Information Processing System According to the Second Embodiment of the Present Disclosure]

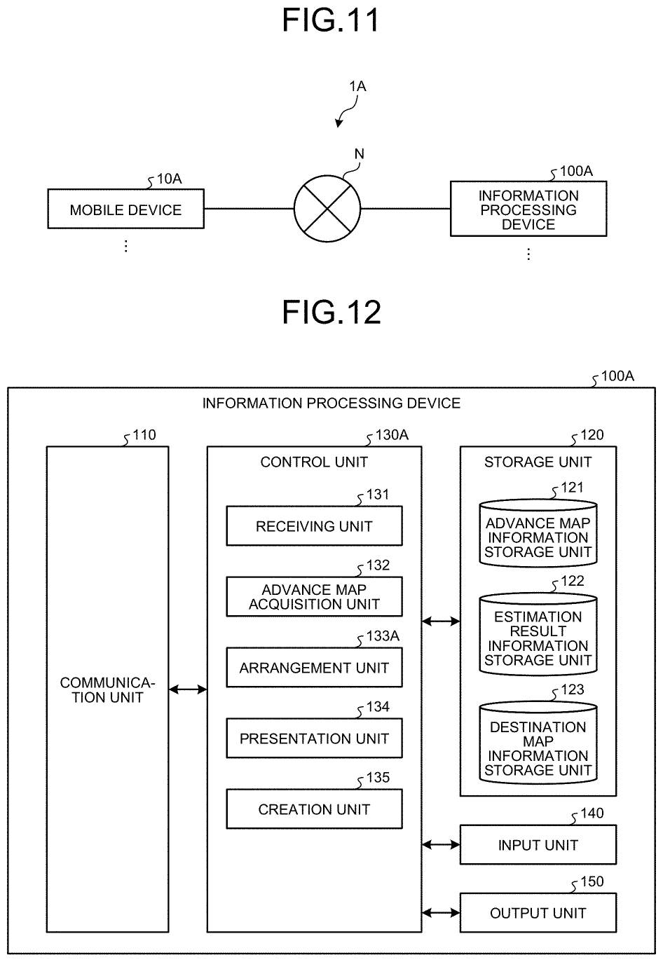

An information processing system 1A illustrated in FIG. 11 will be described. FIG. 11 is a diagram illustrating a configuration example of the information processing system according to the second embodiment of the present disclosure. As illustrated in FIG. 11, the information processing system 1A includes a mobile device 10A and an information processing device 100A. The mobile device 10A and the information processing device 100A are communicably connected by wire or wirelessly via the network N. Note that the information processing system 1A illustrated in FIG. 11 may include the plurality of mobile devices 10A and the plurality of information processing devices 100A.

[2-2. Configuration of Information Processing Device According to the Second Embodiment]

Next, a configuration of the information processing device 100A that is an example of an information processing device that executes information processing according to the second embodiment will be described. FIG. 12 is a diagram illustrating a configuration example of the information processing device according to the second embodiment.

As illustrated in FIG. 12, the information processing device 100A includes a communication unit 110, a storage unit 120, a control unit 130A, an input unit 140, and an output unit 150. The storage unit 120 stores various types of information about an object. The storage unit 120 may include an object information storage unit that stores various types of information about an object.

The control unit 130A is implemented by, for example, a CPU, an MPU, or the like executing a program (for example, an information processing program or the like according to the present disclosure) stored inside the information processing device 100A using a RAM or the like as a work area. Furthermore, the control unit 130A is a controller, and is realized by, for example, an integrated circuit such as an ASIC or an FPGA.

As illustrated in FIG. 12, the control unit 130A includes a receiving unit 131, an advance map acquisition unit 132, an arrangement unit 133A, a presentation unit 134, and a creation unit 135, and implements or executes a function and an action of information processing described below. Note that the internal configuration of the control unit 130A is not limited to the configuration illustrated in FIG. 12, and may be another configuration as long as information processing to be described later is performed. Furthermore, the connection relationship between the processing units included in the control unit 130A is not limited to the connection relationship illustrated in FIG. 12, and may be another connection relationship.

The arrangement unit 133A performs various processes similarly to the arrangement unit 133. The arrangement unit 133A arranges nodes. The arrangement unit 133A arranges, in the advance map, the object recognized based on the information about an image captured by the imaging unit (image sensor 142). The arrangement unit 133A arranges, in the advance map, the object recognized based on the information about an image captured by the imaging unit of the mobile device 10. The arrangement unit 133A arranges, in the advance map, the object recognized by an object recognition unit 139.

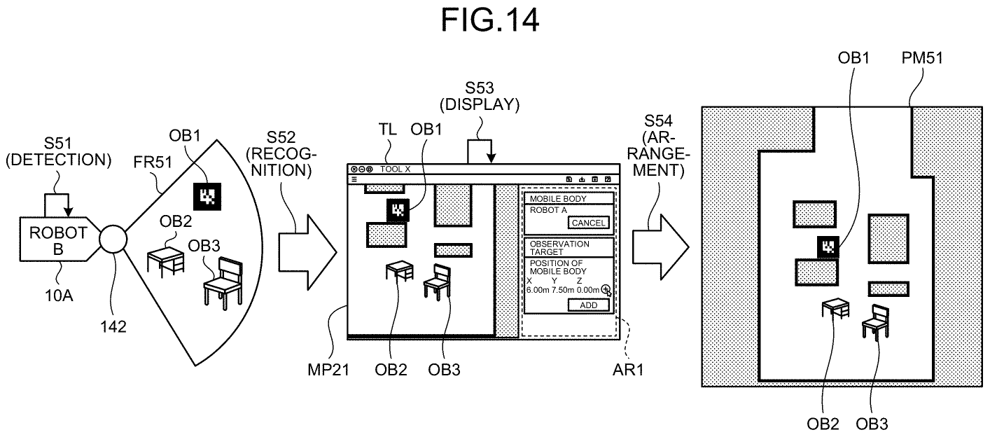

In the example of FIG. 14, the arrangement unit 133A arranges objects OB1 to OB3. The arrangement unit 133A arranges the objects OB1 to OB3 according to selection by the user. The arrangement unit 133A arranges and records the objects OB1 to OB3 in an advance map PM51 by a UI operation by the user. The arrangement unit 133A adds an icon of the object OB1 at a position in the advance map PM51 corresponding to the coordinate information about the object OB1. The arrangement unit 133A adds an icon of the object OB2 at a position in the advance map PM51 corresponding to the coordinate information about the object OB2. The arrangement unit 133A adds an icon of the object OB3 at a position in the advance map PM51 corresponding to the coordinate information about the object OB3. The arrangement unit 133A arranges the objects OB1 to OB3 in the advance map PM51.

[2-3. Configuration of Mobile Device According to the Second Embodiment]

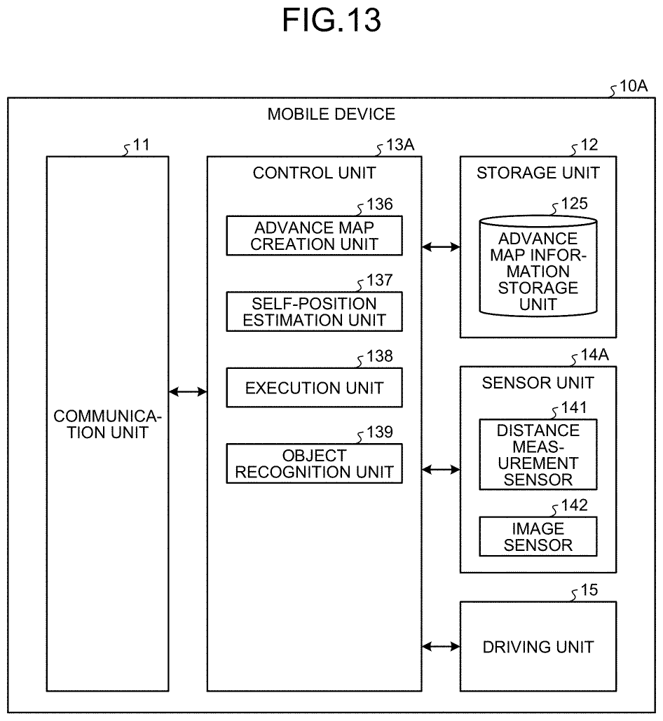

A configuration of the mobile device 10A, which is an example of a mobile body that executes information processing according to the second embodiment, will be described. FIG. 13 is a diagram illustrating a configuration example of the mobile device according to the second embodiment.

As illustrated in FIG. 13, the mobile device 10A includes a communication unit 11, a storage unit 12, a control unit 13A, a sensor unit 14A, and a driving unit 15.

The control unit 13A is realized by, for example, a CPU, an MPU, or the like executing a program (for example, an information processing program according to the present disclosure) stored inside the mobile device 10 using a RAM or the like as a work area. The control unit 13A may be realized by, for example, an integrated circuit such as an ASIC or an FPGA.

As illustrated in FIG. 13, the control unit 13A includes an advance map creation unit 136, a self-position estimation unit 137, an execution unit 138, and an object recognition unit 139, and implements or executes a function and an action of information processing described below. Note that the internal configuration of the control unit 13A is not limited to the configuration illustrated in FIG. 13, and may be another configuration as long as information processing to be described later is performed.

The object recognition unit 139 recognizes an object. The object recognition unit 139 recognizes an object using various types of information. The object recognition unit 139 generates various types related to the recognition result of the object. The object recognition unit 139 recognizes an object based on the information detected by the sensor unit 14A. The object recognition unit 139 recognizes an object using sensor information detected by various sensors of the sensor unit 14A. The object recognition unit 139 recognizes an object using information (sensor information) about an image captured by the image sensor 142. The object recognition unit 139 recognizes an object included in the image information. The object recognition unit 139 recognizes an obstacle imaged by the image sensor 142.

The object recognition unit 139 detects an object included in the image detected by the image sensor 142 by appropriately using various conventional techniques related to object recognition such as general object recognition. For example, the object recognition unit 139 detects an object in the image detected by the image sensor 142 by appropriately using various conventional techniques related to object recognition such as general object recognition.

Furthermore, the object recognition unit 139 estimates the position of the detected object. The object recognition unit 139 estimates the position of the detected object based on the position of the mobile device 10A. The object recognition unit 139 estimates the coordinates of the detected object based on the position of the mobile device 10A. The object recognition unit 139 estimates the position of the object based on the distance between the self-position estimated by the self-position estimation unit 137 and the object in the image. The object recognition unit 139 estimates the position of the object by appropriately using various conventional techniques related to the object position in the image. The object recognition unit 139 generates an object position estimation result indicating the estimated position of the object.

The execution unit 138 transmits information indicating the position, of the object, estimated by the object recognition unit 139 to the information processing device 100A.

The sensor unit 14A detects predetermined information. The sensor unit 14A includes the distance measurement sensor 141 and the image sensor 142. The image sensor 142 functions as an imaging unit that captures an image. The image sensor 142 detects image information.

[2-4. Overview of Information Processing According to the Second Embodiment]

Next, an overview of information processing according to the second embodiment will be described with reference to FIG. 14. FIG. 14 is a diagram illustrating an example of information processing according to the second embodiment. The information processing according to the second embodiment is realized by the information processing system 1A including the mobile device 10A illustrated in FIG. 14 and the information processing device 100A (see FIG. 12). FIG. 14 illustrates an example in which the mobile device 10A arranges a recognized object in a map. In addition, the mobile device 10A is a robot B (information processing device) that similarly to the mobile device 10, creates an advance map corresponding to the travel environment based on the distance measurement result by the distance measurement sensor 141 (see FIG. 13) to perform self-position estimation based on the advance map. The information processing device 100A arranges, in the advance map, an object recognized based on information about an image captured by the image sensor 142, which is a camera included in the mobile device 10A.

An outline of the process of arranging, in the map, the object recognized by the mobile device 10A will be described below with reference to FIG. 14. The example of FIG. 14 illustrates a case where a connection between the robot B, which is the mobile device 10A, and the information processing device 100A is established. The mobile device 10A performs detection by the image sensor 142 that is the LiDAR (step S51). Mobile device 10A detects image information in an imaging range FR51 of the image sensor 142. The mobile device 10A detects image information including the objects OB1 to OB3 and the like located within the imaging range FR51. The mobile device 10A collects image information detected in the imaging range FR51 of the image sensor 142 while traveling. The mobile device 10A collects image information by detection by the image sensor 142 while traveling a place where the mobile device 10A autonomously travels.

The mobile device 10A recognizes an object using the detected image information (step S52). The mobile device 10A recognizes an object included in an image detected by the image sensor 142 by appropriately using various conventional techniques related to object recognition such as general object recognition. In the example of FIG. 14, the mobile device 10A recognizes the objects OB1 to OB3 and the like. The mobile device 10A recognizes an object OB1 that is, for example, an augmented reality (AR) marker. Furthermore, the mobile device 10A estimates the position of the object OB1 based on the positional relationship between the self-position and the object OB1. The mobile device 10A recognizes an object OB2 that is, for example, a desk. Furthermore, the mobile device 10A estimates the position of the object OB2 based on the positional relationship between the self-position and the object OB2. The mobile device 10A recognizes an object OB3 that is, for example, a chair. Furthermore, the mobile device 10A estimates the position of the object OB3 based on the positional relationship between the self-position and the object OB3.

Then, the mobile device 10A transmits information about the recognized objects OB1 to OB3 to the information processing device 100A. The mobile device 10A transmits information indicating that the object OB1 is an AR marker and coordinate information indicating the estimated position of the object OB1 to the information processing device 100A. The mobile device 10A transmits information indicating that the object OB2 is a desk and coordinate information indicating the estimated position of the object OB2 to the information processing device 100A. The mobile device 10A transmits information indicating that the object OB3 is a chair and coordinate information indicating the estimated position of the object OB3 to the information processing device 100A. The mobile device 10A transmits an object recognized in real time and coordinate information indicating the position of the object to the information processing device 100A.

The information processing device 100A displays various types of information received from the mobile device 10A (step S53). The information processing device 100A displays a map or an object on the tool screen TL of the tool X. The information processing device 100A displays the objects OB1 to OB3 on a map MP21 corresponding to a part of the advance map PM51. The information processing device 100A displays the objects OB1 to OB3 on the map MP21 based on the information indicating the positions of the objects OB1 to OB3. In this manner, the information processing device 100A displays the type and coordinates of the object which the mobile device 10A can currently see, that is, positioned within the imaging range FR51 of the mobile device 10A, on the tool screen TL of the tool X. The information processing device 100A may display an object in accordance with a user's instruction. For example, the information processing device 100A may arrange an object on a map and display the object in accordance with selection of the object by the user.

The information processing device 100A arranges an object (step S54). The information processing device 100A arranges the objects OB1 to OB3. The information processing device 100A arranges the objects OB1 to OB3 according to selection by the user. In a case where the user selects an icon corresponding to the object OB1 displayed on the screen, the information processing device 100A may register (arrange) the object OB1 by adding information about the type and coordinates of the object OB1 to the storage unit 120. For example, the information processing device 100A may display a UI for object arrangement on the area AR1 and arrange the objects OB1 to OB3 according to a user's operation on the UI for object arrangement. The information processing device 100A arranges and records the objects OB1 to OB3 in the advance map PM51 by the UI operation by the user. The information processing device 100A adds an icon of the object OB1 at a position in the advance map PM51 corresponding to the coordinate information about the object OB1. The information processing device 100A adds an icon of the object OB2 at a position in the advance map PM51 corresponding to the coordinate information about the object OB2. The information processing device 100A adds an icon of the object OB3 at a position in the advance map PM51 corresponding to the coordinate information about the object OB3. In this manner, the information processing device 100A arranges the objects OB1 to OB3 in the advance map PM51.

As described above, the information processing system 1A can create the map information reflecting the object located at the place where the mobile body moves by arranging the recognized object on the advance map. In this manner, the information processing system 1A can recognize an object whose position is desired to be embedded in the advance map and embed the object in the coordinate system on the advance map. As a result, the information processing system 1A can arrange the AR marker disposed in the real world and the landmarks such as a desk or a chair at the coordinates on the advance map. Furthermore, in the information processing system 1A, the AR marker and the landmarks embedded in the advance map can be used for self-position estimation, or can be used as an action purpose (destination or the like).

### 3. Other Embodiments

The processing according to each embodiment described above may be performed in various different forms (modifications) other than the embodiments described above.

[3-1. Other Configuration Examples]

For example, in the above-described example, an example is described in which the information processing device 100, 100A that performs information processing and the mobile device 10, 10A are separate devices. However, the information processing device and the mobile devices may be integrated. For example, the actual robot and the tool may be integrated. For example, a mobile device that is an actual robot and an information processing device on which a tool is mounted (installed) may be integrated. For example, the tool may be mounted (installed) on the actual robot or may be mounted (installed) on the information processing device.

[3-2. Example of Mobile Body]

As described above, the mobile device (mobile body) may be any device as long as the processing in the embodiment can be realized. For example, in a case where the mobile body is a vehicle, it may be used for automatic parking of the mobile body or the like. Also in automatic driving, self-position estimation may be performed using a map (high precision map) based on a point group such as the LiDAR. For example, even in a case where severe accuracy is required, such as parking, it is possible to perform parking by automatic driving or the like more safely and accurately by designating a destination (parking position) (for example, arrangement of nodes or the like) at a self-position on a high-accuracy map.

[3-3. Others]

Further, it is also possible to manually perform all or part of the processing described as being performed automatically in the processing described in the above embodiment, or alternatively, it is also possible to automatically perform all or part of the processing described as being performed manually by a known method. In addition, the processing procedure, specific name, and information including various pieces of data and parameters illustrated in the above document and drawings can be arbitrarily changed unless otherwise specified. For example, the various types of information illustrated in each figure are not limited to the illustrated information.

Further, each component of each of the illustrated devices is a functional concept, and does not necessarily have to be physically configured as illustrated in the figure. That is, the specific form of distribution/integration of each device is not limited to the one illustrated in the figure, and all or part of the device can be functionally or physically distributed/integrated in any unit according to various loads and usage conditions.

Further, the above-described embodiments and modifications can be appropriately combined in a range where the processing contents do not contradict each other.

Further, the effects described in the present specification are merely examples and are not limiting, and other effects may be present.

### 4. Effects According to the Present Disclosure

As described above, an information processing system (in the embodiment, the information processing system 1, 1A) according to the present disclosure includes a mobile body (in the embodiment, the mobile device 10, 10A) that creates an advance map corresponding to a travel environment based on a distance measurement result by a distance measurement sensor (in the embodiment, the distance measurement sensor 141) to perform self-position estimation based on the advance map and an information processing device (in the embodiment, the information processing device 100, 100A) that arranges nodes in the advance map. The information processing device includes a receiving unit (in the embodiment, the receiving unit 131) that receives a self-position estimation result of the mobile body in the advance map, and a node arrangement unit (in the embodiment, the arrangement unit 133) that arranges nodes in the advance map based on the self-position estimation result.

As a result, the information processing system according to the present disclosure can create the advance map corresponding to the travel environment based on the distance measurement result by the distance measurement sensor, and arrange the nodes in the advance map based on the self-position estimation result of the mobile body in the advance map, and thus can appropriately create the map information according to the position of the mobile body. In the information processing system, since the nodes are arranged on the advance map based on the information observed by the mobile body actually traveling and the map is updated, the nodes can be arranged on the advance map based on the coordinate system from the actual observation result different from the coordinate system of the advance map. In the information processing system, by setting the destination while calculating the self-position in the coordinate system on the advance map, it is possible to minimize the influence of distortion, deviation, and the like of the advance map.

In addition, the node arrangement unit arranges the node at the position on the advance map based on the self-position estimation result of the mobile body indicating a position on the advance map. As a result, the information processing system can appropriately create the map information according to the position of the mobile body by arranging the node at a position on the advance map.

In addition, the node arrangement unit arranges the nodes at the coordinates on the advance map based on the self-position estimation result of the mobile body indicating the coordinates on the advance map. As a result, the information processing system can appropriately create the map information according to the position of the mobile body by arranging the nodes at the coordinates on the advance map.

In addition, the mobile body moves while performing self-position estimation based on the advance map. As a result, the information processing system can appropriately create the map information according to the position of the mobile body by using the information about the mobile body that moves while performing self-position estimation based on the advance map.

In addition, the mobile body creates the advance map based on a distance measurement result by a distance measurement sensor mounted on the mobile body. As a result, the information processing system can appropriately create the map information according to the position of the mobile body by using the advance map based on the distance measurement result by the distance measurement sensor mounted on the mobile body.

In addition, the mobile body creates the advance map by moving in the travel environment. As a result, the information processing system can appropriately create the map information according to the position of the mobile body by using the advance map based on the distance measurement result by the mobile body that has moved in the travel environment.

Furthermore, the node arrangement unit arranges the nodes according to selection by the user. As a result, the information processing system can arrange the nodes in accordance with the intention of the user by arranging the nodes in accordance with selection by the user, and can appropriately create the map information according to the position of the mobile body.

Furthermore, the information processing device includes a presentation unit (in the embodiment, the presentation unit 134) that presents a self-position estimation result to the user. The node arrangement unit arranges the nodes according to selection by the user to which the self-position estimation result is presented by the presentation unit. As a result, in the information processing system, the user can select the position where the node is to be arranged while the user confirms the self-position estimation result of the mobile body, so that the map information can be appropriately created according to the position of the mobile body.

Furthermore, the presentation unit displays the self-position estimation result on the screen. The node arrangement unit arranges the nodes according to selection by the user with respect to the self-position estimation result displayed on the screen. As a result, the information processing system enables the user to select the position where the node is to be arranged while the user confirms the self-position estimation result of the mobile body displayed on the screen, and thus, it is possible to appropriately create the map information according to the position of the mobile body.

In addition, the node arrangement unit arranges the nodes in accordance with the operation of the button by the user. As a result, the information processing system enables the user to select the position where the node is to be arranged by the user operating the button, so that the map information can be appropriately created according to the position of the mobile body.

Furthermore, the information processing device includes a creation unit (in the embodiment, the creation unit 135) that creates a destination map based on the nodes arranged by the node arrangement unit. As a result, the information processing system can appropriately create map information such as a destination map according to the position of the mobile body.

Furthermore, the information processing device includes an object arrangement unit (in the embodiment, the arrangement unit 133A) that arranges, in the advance map, an object recognized based on information about an image captured by an imaging unit (in the embodiment, the image sensor 142). As a result, the information processing system can arrange the object in the advance map, and can appropriately create the map information.

In addition, the mobile body includes an imaging unit. The object arrangement unit arranges, in the advance map, the object recognized based on the information about an image captured by the imaging unit of the mobile body. As a result, the information processing system can arrange, in the advance map, the object detected by the mobile body, and can appropriately create the map information according to the position of the mobile body.

Furthermore, the information processing device includes an advance map acquisition unit (in the embodiment, the advance map acquisition unit 132) that acquires an advance map of a travel environment of the mobile body, a receiving unit that receives an self-position estimation result of the mobile body indicating the advance map, and a node arrangement unit that arranges nodes in the advance map based on the self-position estimation result. As a result, the information processing device can appropriately create the map information according to the position of the mobile body.

### 5. Hardware Configuration

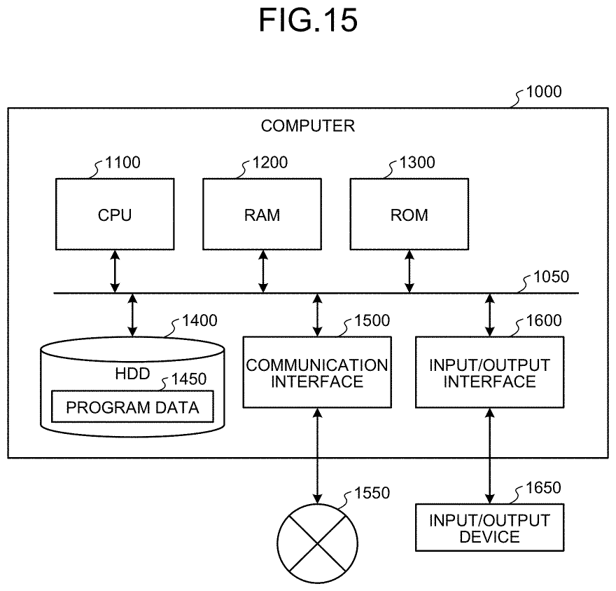

The information devices such as the information processing device 100, 100A and the mobile device 10, 10A according to the above-described embodiments are realized by the computer 1000 having a configuration as illustrated in FIG. 15, for example. FIG. 15 is a hardware configuration diagram illustrating an example of the computer 1000 that implements functions of information processing devices such as the information processing device 100, 100A and the mobile device 10, 10A. Hereinafter, the information processing device 100 according to the first embodiment will be described as an example. The computer 1000 includes a CPU 1100, a RAM 1200, a read only memory (ROM) 1300, a hard disk drive (HDD) 1400, a communication interface 1500, and an input/output interface 1600. Respective units of the computer 1000 are connected by a bus 1050.

The CPU 1100 operates based on a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records programs executed by the CPU 1100, data used by the programs, and the like. Specifically, the HDD 1400 is a recording medium that records an information processing program according to the present disclosure which is an example of program data 1450.

The communication interface 1500 is an interface for the computer 1000 to be connected to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like. For example, in a case where the computer 1000 functions as the information processing device 100 according to the embodiment, the CPU 1100 of the computer 1000 executes the information processing program loaded on the RAM 1200 to implement the functions of the control unit 13 and the like. In addition, the HDD 1400 stores the information processing program according to the present disclosure and data in the storage unit 12. The CPU 1100 reads the program data 1450 from the HDD 1400 and executes the program data, but as another example, the program may be acquired from another device via the external network 1550.

The present technology may also be configured as below.

(1)

An information processing system comprising:

a mobile body that creates an advance map corresponding to a travel environment based on a distance measurement result by a distance measurement sensor to perform self-position estimation based on the advance map; and

an information processing device that arranges a node in the advance map, wherein

the information processing device comprises

a receiving unit that receives a self-position estimation result of the mobile body in the advance map, and

a node arrangement unit that arranges a node in the advance map based on the self-position estimation result.

(2)

The information processing system according to (1), wherein

the node arrangement unit

arranges a node at a position on the advance map based on the self-position estimation result of the mobile body indicating a position on the advance map.

(3)

The information processing system according to (1) or (2), wherein

the node arrangement unit

arranges a node at coordinates on the advance map based on the self-position estimation result of the mobile body indicating coordinates on the advance map.

(4)

The information processing system according to any one of (1) to (3), wherein

the mobile body

moves while performing the self-position estimation based on the advance map.

(5)

The information processing system according to any one of (1) to (4), wherein

the mobile body

creates the advance map based on the distance measurement result by the distance measurement sensor mounted on the mobile body.

(6)

The information processing system according to any one of (1) to (5), wherein

the mobile body

creates the advance map by moving in the travel environment.

(7)

The information processing system according to any one of (1) to (6), wherein

the node arrangement unit

arranges the node according to selection by a user.

(8)

The information processing system according to (7), wherein

the information processing device further comprises

a presentation unit that presents the self-position estimation result to the user, and wherein

the node arrangement unit

arranges the node according to selection by the user to which the self-position estimation result is presented by the presentation unit.

(9)

The information processing system according to (8), wherein

the presentation unit

displays the self-position estimation result on a screen, and wherein

the node arrangement unit

arranges the node according to selection by the user with respect to the self-position estimation result displayed on the screen.

(10)

The information processing system according to any one of

(7) to (9), wherein the node arrangement unit arranges the node according to an operation of a button by the user.
(11)

The information processing system according to any one of

(1) to (10), wherein

the information processing device further comprises

a creation unit that creates a destination map based on the node arranged by the node arrangement unit.

(12)

The information processing system according to any one of (1) to (11), wherein

the information processing device further comprises

an object arrangement unit that arranges, in the advance map, an object recognized based on information about an image captured by an imaging unit.

(13)

The information processing system according to (12), wherein

the mobile body comprises

the imaging unit, and wherein

the object arrangement unit

arranges, in the advance map, the object recognized based on the information about the image captured by the imaging unit of the mobile body.

(14)

An information processing device comprising:

an advance map acquisition unit that acquires an advance map of a travel environment of a mobile body;

a receiving unit that receives a self-position estimation result of the mobile body indicating the advance map; and

a node arrangement unit that arranges a node in the advance map based on the self-position estimation result.

(15)

An information processing method comprising:

a mobile body creating an advance map corresponding to a travel environment based on a distance measurement result by a distance measurement sensor to perform self-position estimation based on the advance map; and

an information processing device receiving a self-position estimation result of the mobile body in the advance map, and

arranging a node in the advance map based on the self-position estimation result.

(16)

An information processing method comprising:

acquiring an advance map of a travel environment of a mobile body;

receiving a self-position estimation result of the mobile body indicating the advance map; and

arranging a node in the advance map based on the self-position estimation result.

### REFERENCE SIGNS LIST

100, 100A INFORMATION PROCESSING DEVICE
110 COMMUNICATION UNIT
120 STORAGE UNIT
121 ADVANCE MAP INFORMATION STORAGE UNIT
122 ESTIMATION RESULT INFORMATION STORAGE UNIT
123 DESTINATION MAP INFORMATION STORAGE UNIT
130, 130A CONTROL UNIT
131 RECEIVING UNIT
132 ADVANCE MAP ACQUISITION UNIT
133, 133A ARRANGEMENT UNIT
134 PRESENTATION UNIT
135 CREATION UNIT
140 INPUT UNIT
150 OUTPUT UNIT
10, 10A MOBILE DEVICE
11 COMMUNICATION UNIT
12 STORAGE UNIT
125 ADVANCE MAP INFORMATION STORAGE UNIT
13, 13A CONTROL UNIT
136 ADVANCE MAP CREATION UNIT
137 SELF-POSITION ESTIMATION UNIT
138 EXECUTION UNIT
139 OBJECT RECOGNITION UNIT
14, 14A SENSOR UNIT
141 DISTANCE MEASUREMENT SENSOR
142 IMAGE SENSOR
15 DRIVING UNIT

1. An information processing system comprising:
a mobile body that creates an advance map corresponding to a travel environment based on a distance measurement result by a distance measurement sensor to perform self-position estimation based on the advance map; and
an information processing device that arranges a node in the advance map, wherein
the information processing device comprises
a receiving unit that receives a self-position estimation result of the mobile body in the advance map, and
a node arrangement unit that arranges a node in the advance map based on the self-position estimation result.

2. The information processing system according to claim 1, wherein
the node arrangement unit
arranges a node at a position on the advance map based on the self-position estimation result of the mobile body indicating a position on the advance map.

3. The information processing system according to claim 1, wherein
the node arrangement unit
arranges a node at coordinates on the advance map based on the self-position estimation result of the mobile body indicating coordinates on the advance map.

4. The information processing system according to claim 1, wherein
the mobile body
moves while performing the self-position estimation based on the advance map.

5. The information processing system according to claim 1, wherein
the mobile body
creates the advance map based on the distance measurement result by the distance measurement sensor mounted on the mobile body.

6. The information processing system according to claim 1, wherein
the mobile body
creates the advance map by moving in the travel environment.

7. The information processing system according to claim 1, wherein
the node arrangement unit
arranges the node according to selection by a user.

8. The information processing system according to claim 7, wherein
the information processing device further comprises
a presentation unit that presents the self-position estimation result to the user, and wherein
the node arrangement unit
arranges the node according to selection by the user to which the self-position estimation result is presented by the presentation unit.

9. The information processing system according to claim 8, wherein
the presentation unit
displays the self-position estimation result on a screen, and wherein
the node arrangement unit
arranges the node according to selection by the user with respect to the self-position estimation result displayed on the screen.

10. The information processing system according to claim 7, wherein
the node arrangement unit
arranges the node according to an operation of a button by the user.

11. The information processing system according to claim 1, wherein
the information processing device further comprises
a creation unit that creates a destination map based on the node arranged by the node arrangement unit.

12. The information processing system according to claim 1, wherein
the information processing device further comprises
an object arrangement unit that arranges, in the advance map, an object recognized based on information about an image captured by an imaging unit.

13. The information processing system according to claim 12, wherein
the mobile body comprises
the imaging unit, and wherein
the object arrangement unit
arranges, in the advance map, the object recognized based on the information about the image captured by the imaging unit of the mobile body.

14. An information processing device comprising:
an advance map acquisition unit that acquires an advance map of a travel environment of a mobile body;
a receiving unit that receives a self-position estimation result of the mobile body indicating the advance map; and
a node arrangement unit that arranges a node in the advance map based on the self-position estimation result.

15. An information processing method comprising:
a mobile body creating an advance map corresponding to a travel environment based on a distance measurement result by a distance measurement sensor to perform self-position estimation based on the advance map; and
an information processing device receiving a self-position estimation result of the mobile body in the advance map, and
arranging a node in the advance map based on the self-position estimation result.

16. An information processing method comprising:
acquiring an advance map of a travel environment of a mobile body;
receiving a self-position estimation result of the mobile body indicating the advance map; and
arranging a node in the advance map based on the self-position estimation result.
